(19) United States
(12) Patent Application Publication
(10) Pub. No.: US 2007/0010282 A1
(43) Pub. Date: Jan. 11, 2007

(54) Cellular telephone system improvement - known as the "007 WEB"

(76) Inventor: Eric T. Dates, Anderson, IN (US)

Correspondence Address: RITCHISON LAW OFFICES, PC, 115 EAST NINTH STREET - SUITE A, ANDERSON, IN, 46016-1507, US

(21) Appl. No.: 11/471,815

(22) Filed: Jun. 21, 2006

Related U.S. Application Data
(60) Provisional application No. 60/693,142, filed on Jun. 23, 2005.

(51) Int. Cl. H04M 1/00

(52) U.S. Cl. 455/550.1

(57) ABSTRACT

A communications device which is a cellular telephone comprised of several key components. The device includes a cellular telephone set; internal to the telephone, a specifically designed SIMMS chip from which the majority of the added functions are derived; and an earpiece to connect to the telephone. Both the telephone and earpiece have transducers to interconnect via transmitters and receivers. An integral, rechargeable main and back-up power supplies (batteries) accompany both the telephone and earpiece. The concept of the device is centered specifically on providing media exchange and computer-like capabilities as the migration of micro-electronics advances. These advances include allowing electronic devices to become more powerful and comprehensive; providing the capability to collect and store data in larger quantities with relatively small components; and, providing advanced features in cellular telephones that were previously unable to contain the features in small and portable cellular packages.

### CROSS-REFERENCE TO RELATED APPLICATIONS

None

This application claims the benefit of Provisional Patent Application Ser. No. 60/693,142 filed Jun. 23, 2005 by Eric T. Dates and titled “CELLULAR TELEPHONE SYSTEM IMPROVEMENT—Known as the “007 WEB””.

### FIELD OF INVENTION

The present invention, a Cellular Telephone System Improvement known as the “007 WEB”, relates to the field of cellular communication and improving the normal telephonic communication with a myriad of various other functions that an end consumer will find helpful, relatively inexpensive when coupled with the cellular telephone, and time efficient.

### FEDERALLY SPONSORED RESEARCH

None

### SEQUENCE LISTING OR PROGRAM

None

### BACKGROUND

1. Field of Invention

The present invention crosses several fields of inventions. Primarily, the Cellular Telephone System Improvement known as the “007 WEB” relates to the telephonic and computer enhanced telecommunication industry. Traditionally, the communication has been accomplished by “hard wired” and physically connected systems. Recently, more of the industry has migrated to a telephonic system that is often called “wireless” or “cellular”. As this wireless system has progressed, other technology has started to evolve in order to allow improvement in the scope and timeliness of providing information via the telephone. Much of the information transferred by the “007 WEB” is information that is desired for a consumer, that is required for a business, or that is needed for an individual to quickly make an informed decision. Most of the industries related to computer technologies and media exchange have focused their efforts on adding some of the new communication features to their computer based devices—hand-held computers, palm tops, personal digital assistants and the like (hereinafter collectively referred to as PDAs (Personal Digital Assistants). These devices afforded more physical space to permit some storage of data and provide circuitry with predetermined functions. This current device, the Cellular Telephone System Improvement known as the “007 WEB”, is focused on adding many of the computer and media functions to the already existing cellular telephone. This addition is accomplished by the adding microchips, memory, and other wireless hardware to provide a system that functions with the existing cellular telephone. To date, none of the manufacturers are known to provide a telephone with these unique features.

2. Prior Art

A. Introduction of the Problems Addressed

None of the prior art discovered to date teaches all the features and capabilities of the CELLULAR TELEPHONE IMPROVEMENT—“007 WEB” in respect to the use of a cellular telephone as the base mechanism or device that is then enhanced with various other features, functions and options.

B. Prior Art

Historically, wireless or cellular telephones have continued to evolve into smaller devices. This evolution to relatively smaller physical sizes has been somewhat restrictive as to what functions and features could be present in the devices. This was due to the relative size of the microchips (controls) and memory chips (memory). Mostly this size restriction resulted in the specific telephone device having to “choose” the functions and features to be present in a given model of telephone. At present, currently telephone devices are limited in the functions and interchange and storage of data from media sources. With the technology now present, the mini-chips and mini-memory, the telephone features and functions may offer many more combinations, which is the basic premise offered by the Cellular Telephone System Improvement known as the “007 WEB”.

Examples of prior cellular telephones with remote ear pieces begin with U.S. Pat. No. 5,613,222 issued to Guenther (1997) which taught the ability for a head-set/earpiece to be utilized as part of a cellular telephone system. The earpiece uses a transceiver to communicate with the main body of the cellular telephone. The device teaches none of the media exchange or duplicate control (from the telephone and the earpiece) as taught with the present CELLULAR TELEPHONE IMPROVEMENT system described here.

Another telephone ear receiver is taught in U.S. Pat. No. 5,655,026 issued to Peters et al (1997) which taught a receiver, support arm and wire connection to the main telephone device. This does not describe the plethora of features now available with the advent of miniature/micro electronic control, devices, and storage means.

Next, additional prior art is divulged in U.S. Pat. No. 5,751,820 issued to Taenzer (1998) which taught an improved design to compensate for the hearing impaired. Further, U.S. Pat. No. 5,761,298 issued to Davis et al (1998) teaches a remote head set and various connections to the set. Some limited transfers of data and media are taught.

U.S. Pat. No. 5,790,683 issued to Salazani (1998) depicted and taught a separate headphone and telephone device. It did not pursue the specific (new) uses of the CELLULAR TELEPHONE IMPROVEMENT system—“007 WEB” device.

In U.S. Pat. No. 6,021,207 (by Puthuff et al.) a wireless ear piece, in conjunction with the more complex and bulky PDAs, is shown. This device demonstrates a universal connection means to connect the communication device to several date media interchanging companies. Another invention by Puthuff, U.S. Pat. No. 6,112,103, demonstrates a method to connect a cellular telephone to other media devices such as a PDA; hardwired and wireless computers; and wireless and hardwired telephones.

The U.S. Pat. No. 6,230,029 issued to Hahan, et al and entitled “modular wireless headset system” demonstrates a remote headset system used with a PDA and/or wireless telephone device. This innovation teaches an interconnect system which could be used to promote and support the system developed herein as the Cellular Telephone System Improvement known as the “007 WEB”.

In publication US 2002/0068605A1, a control device for various telephones and PDAs is shown. This control is located and resident on another control mechanism such as a steering wheel (shown here as the preferred embodiment). One skilled in the art of telecommunication and microelectronics appreciates that the control system is improved significantly by incorporating the control with the telephone and earpiece as taught in the present invention.

For the publication US 2002/0132585 A1, by Patermo, et al one sees a device that has a device that may contain one or more received messages which can be analyzed to determine whether a transceiver device generating the inductive field has already been programmed with a unique communication code. If not, bidirectional communications can be established to program the transceiver device with a unique communication code over an inductive link. Generally, the communication code can define a unique relationship between two or more transceiver devices.

U.S. Pat. No. 6,560,468 issued to Boesen (2003) taught a cellular telephone with a transceiver and earpiece with added features that permit some features and functions to be possible with the above described combination. It does not teach or anticipate the scope and breadth of functions and features included with the CELLULAR TELEPHONE IMPROVEMENT system—“007 WEB”.

U.S. Pat. No. 6,718,163 issued to Tandy (2004) is called methods of operating microelectronic devices, and methods of providing microelectronic devices. This teaches for microelectronic devices different operating methods. One embodiment shows a microelectronic device with a housing within which integrated circuitry is placed. The device includes integrated circuits configured to transmit and receive radio frequency signals and various other functioning circuitries. Wireless communication is produced using a transmitter inside the microelectronic package. The produced wireless communication is received using a receiver inside the microelectronic package. Once a communication is received, the integrated circuitry responds and causes the circuit to operate in its designed manner.

None of the prior art discovered to date teaches all the features and capabilities of the CELLULAR TELEPHONE IMPROVEMENT system—“007 WEB” in respect to the telecommunications and media exchange devices and systems currently in use.

### SUMMARY OF THE INVENTION

The CELLULAR TELEPHONE IMPROVEMENT system is described in the combination of various functions used in media exchange as described in this application. The concept of the CELLULAR TELEPHONE IMPROVEMENT system—“007 WEB” is centered specifically around the continuing migration of micro-electronics (or soon nano-electronics) to advance and to become more powerful and comprehensive in the ability to collect and store data in larger quantities. Equally, this technology is migrating to be able to exchange (i.e. transfer and down load) data from satellite up-links and other wireless media systems from major data depositories to the powerful, high capacity devices such as the enhanced cellular phone “007 WEB”—as is described herein.

The CELLULAR TELEPHONE IMPROVEMENT system—“007 WEB” can be assembled and used in many number of positions and ways. The purchaser's and technological advances are the only limit to this system. The configurations used in the traditional sense of providing upgraded and advanced features in electronic devices confirm the realistic application of the below described applications.

The CELLULAR TELEPHONE IMPROVEMENT system—“007 WEB” presented here is comprised of several key components. In a simple combination, first there is a cellular telephone set. Second, internal to the telephone is a specifically designed SIMMS chip from which the majority of added functions are derived. Third, there is a wireless earpiece to provide audio connection to the telephone. Both the telephone and earpiece, of course, have transducers to interconnect. Finally, an integral, rechargeable power supply and a back-up battery accompanies the CELLULAR TELEPHONE SYSTEM IMPROVEMENT—Known as the “007 WEB”. One skilled in the art of electronics and computer design will understand the full spirit and scope of upgrading the telephone as opposed to the current technological direction of adding telephonic capabilities to PDAS.

### OBJECTS AND ADVANTAGES

Accordingly, from the background, prior art and summary shown above, there are several objects and advantages of the Cellular Telephone System Improvement. One advantage of this device over others in the field is its ability to use and easily modify existing telephone systems as opposed to all new electronic devices. The drop-in SIMMs device provides an upgrade to have new features (described in the table below) in existing systems.

A related advantage is that the Cellular Telephone System Improvement known as the “007 WEB” provides an alternative system to PDAs (Personal Digital Assistants). This new invention satisfies a long felt need to have a way to modify existing telephone systems and not incur the higher costs of PDAs. The expanding technology of putting more complex circuits in smaller packages now permit this to be accomplished. Therefore it provides a less expensive alternative to the consumer.

Additionally, most of the materials comprising the device other than the specially designed SIMMs devices are standard and available from many sources.

Finally, other advantages and additional features of the present device and system “007 WEB”—will be more apparent from the accompanying drawings and from the full description of the Cellular Telephone System Improvement —“007 WEB”. For one skilled in the art of cellular and computer related devices and systems it is readily understood that the features shown in the examples with this new device are readily adapted to other types of inventions which are associated with media exchange.

### DESCRIPTION OF THE DRAWINGS

The accompanying drawings, which are incorporated in and constitute a part of this specification, illustrate an embodiment of the present Cellular Telephone System Improvement—“007 WEB” that is preferred. The drawings together with the summary description given above and a detailed description given below serve to explain the principles of the invention. It is understood, however, that the new device and system is not limited to the precise arrangements and instrumentalities shown.

FIG. 1 is DRAWING of the major components the CELLULAR TELEPHONE SYSTEM IMPROVEMENT—Known as the “007 WEB”

FIG. 2 is DRAWINGS of the major components the CELLULAR TELEPHONE SYSTEM IMPROVEMENT—Known as the “007 WEB” with the various subcomponents denoted.

FIG. 3 shows an example of a person using the earpiece.

FIG. 4 shows a series of drawings with several more of the subcomponents.

FIG. 5 show a drawing of the earpiece and telephone with the magnetic boosts displayed.

FIG. 6 is sketches with several subcomponents shown.

FIG. 7 is additional sketches with the subcomponents.

FIG. 8 is a rough sketch of the system with subcomponents and functions described.

FIG. 9 is a rough sketch of the earpiece with subcomponents and functions described in an alternative embodiment.

### DESCRIPTION OF THE DRAWINGS—REFERENCE NUMERALS

The following list refers to the reference items in the drawings describing the “007 WEB”:
30 Cellular Telephone System Improvement known as the “007 WEB”
31 Earpiece SIMMS drop-in Integrated circuit chip combination
31A Telephone SIMMS drop-in Integrated circuit chip combination
32 Telephone Ear piece
32A Back side of earpiece
33 Rechargeable Main Battery
33A Back-up Battery
34 Cellular Telephone Unit
35 Compartment for battery in telephone
35A Compartment for battery in earpiece
36 Microphone on earpiece
37 Earpiece Holder
38 Plug-in connector
39 SIMMS Integrated circuit
40 Heat sink and base for SIMS IC (39)
41 On/Off control button for only cellular telephone
42 Earpiece (32) energy return
43 Direct connect to Internet or other programmed systems) button
44 Telephone (34) energy return
45 Location Finder/surveillance button
46 On system power button
46A Off system power button
47 Volume Control button
48 Call Waiting engage button
49 Person using system
50 Earpiece Transmitter/receiver (transceiver)
50A Telephone transmitter/receiver (transceiver)
51 Antenna
52 Two way calling
52A Two way switch
53 Voice Dialing
54 Viewing Screen
B Magnetic Boost
F Electro-magnetic flux paths

### DETAILED DESCRIPTION OF PREFERRED EMBODIMENT

The present invention is a Cellular Telephone System Improvement—“007 WEB” 30 that has various features to enhance its use. These features are built-in to or integrally attached to the various parts of the Cellular Telephone System Improvement—“007 WEB” 30. The system and features described as concepted here are simple and direct extensions of bulkier and slower features of other less robust devices and systems that have evolved from the communication and media exchange industry. In a simple combination, first there is a cellular telephone set 34. Second, internal to the telephone is a specifically designed SIMMS chip 31 from which the majority of added functions are derived. Third, there is a wireless earpiece 32 to provide audio connection to the telephone. Both the telephone and earpiece, of course, have transducers to interconnect. Finally, an integral, rechargeable power supply 33 and a back-up battery 33A accompanies the CELLULAR TELEPHONE SYSTEM IMPROVEMENT—Known as the “007 WEB” 30.

The Cellular Telephone System Improvement known as the “007 WEB” 30 is demonstrated in the Drawings and further described in detail below. A person having ordinary skill in the field of this invention appreciates the various materials and component parts that may be used to physically permit Cellular Telephone System Improvement known as the “007 WEB” 30 to be produced and utilized. The improvements over the existing art are providing a device that:
(1) has the ability to use and easily modify existing telephone systems;
(2) provides an alternative system to PDAs;
(3) is a less expensive alternative to the consumer; and
(4) is made of materials of which most are standard and readily available.

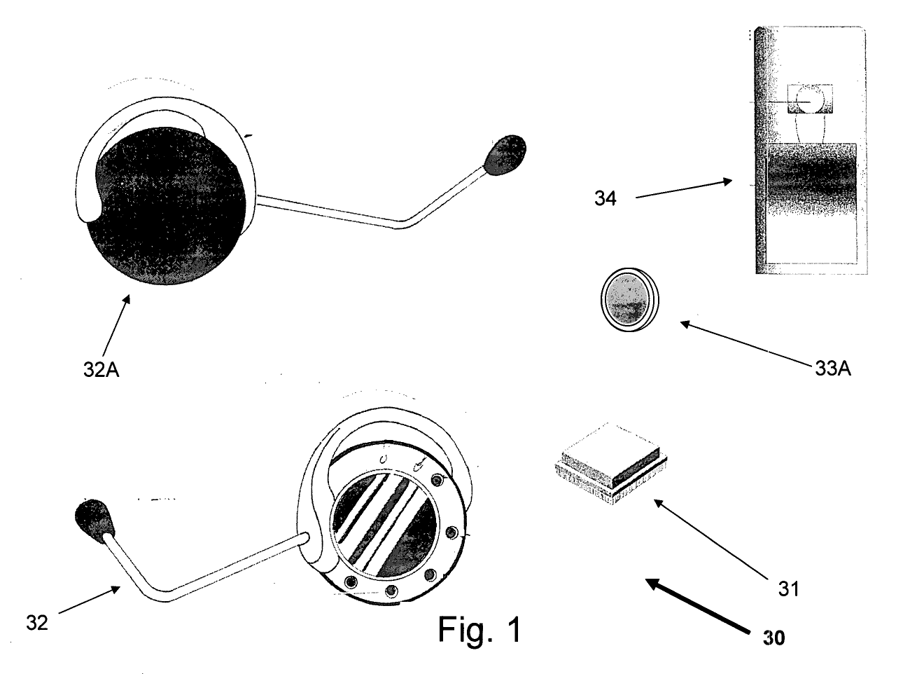

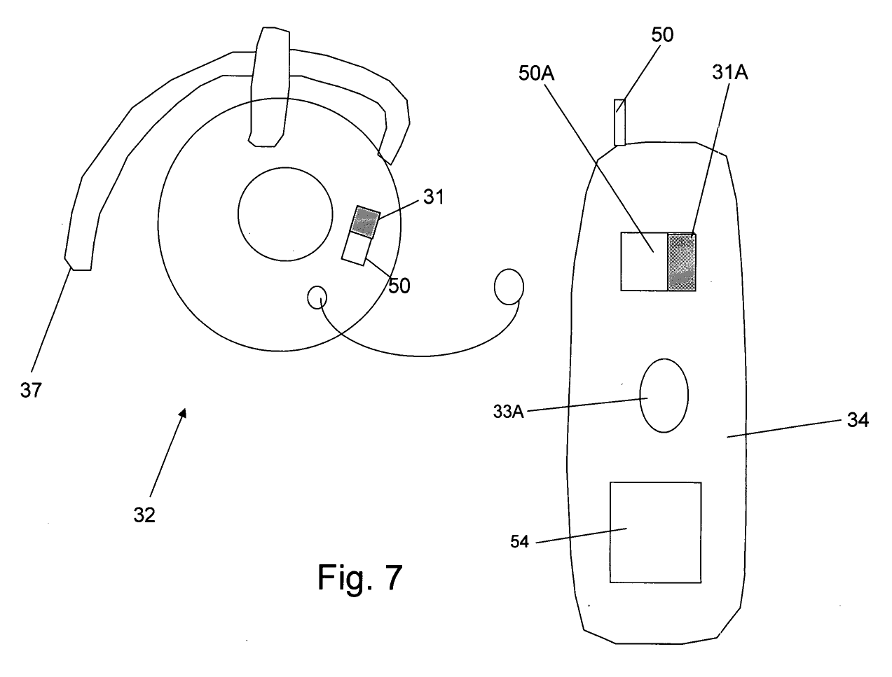

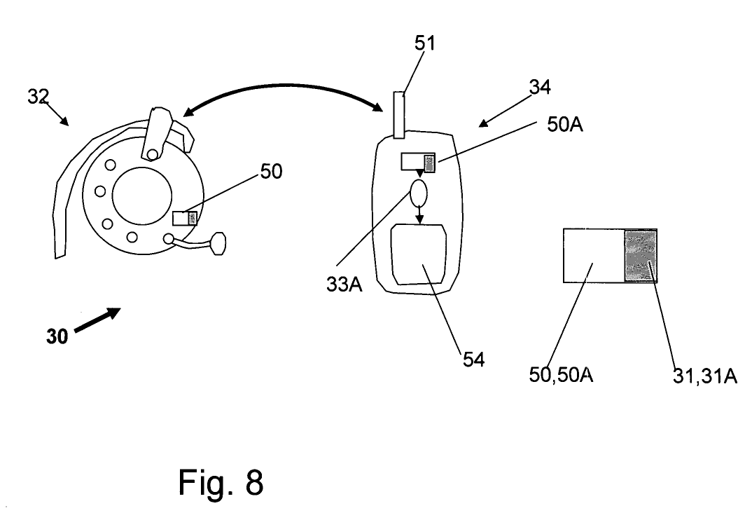

There are shown in FIGS. 1-9 complete operative embodiments of the invention. The invention generally relates to Cellular Telephone System Improvement known as the “007 WEB” 30. The preferred embodiment of the Cellular Telephone System Improvement known as the “007 WEB” 30 is comprised of the parts exemplified in FIGS. 1-4 and FIG. 9 of the drawings.

FIG. 1 is DRAWING of the major components the CELLULAR TELEPHONE SYSTEM IMPROVEMENT—Known as the “007 WEB” 30. The base cellular telephone unit 34 is shown. This view also shows the earpiece from a front view 32 and a rear view 32A perspective. Next, portrayed is the single in-line memory module (SIMMS) chip 31 (or equal) for use in both the earpiece 32 and the cellular telephone 34 is shown. Likewise the rechargeable battery 33A is displayed which is used in both the earpiece 32 and cellular telephone unit 34.

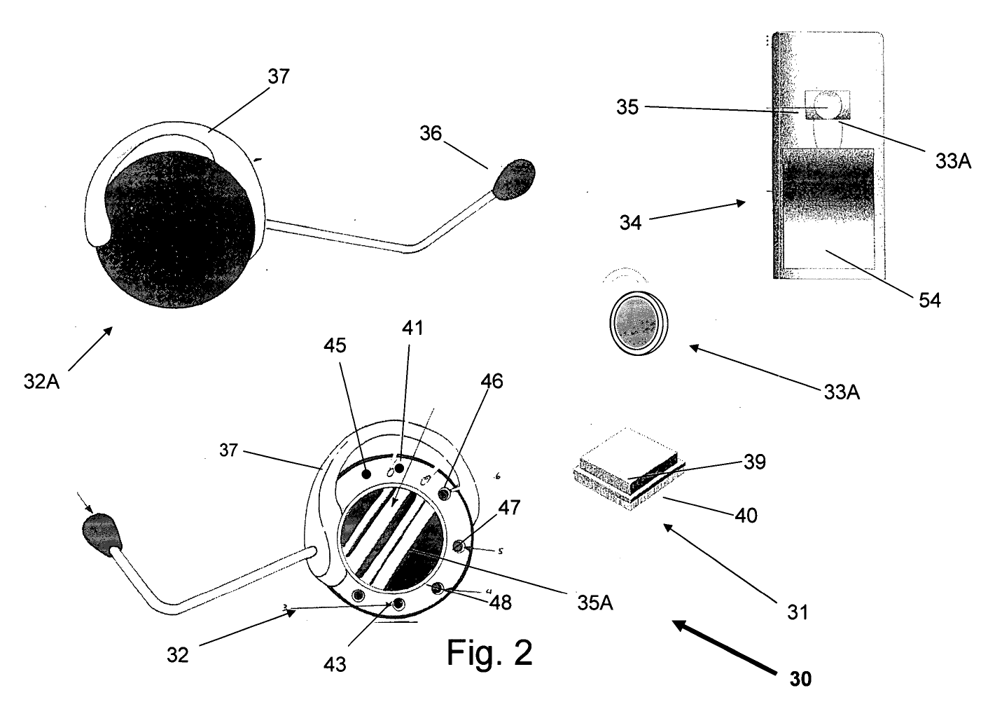

FIG. 2 continues the DRAWINGS of the major components the CELLULAR TELEPHONE SYSTEM IMPROVEMENT—Known as the “007 WEB” 30 with the various sub-components denoted. On the earpiece 32, the subcomponent earpiece holder 37 which encircles the ear of the user—and the microphone extension 36 are depicted. These are made of various materials as one skilled in the art of ear and microphone devices well appreciates. On the body of the earpiece 32, the battery compartment 35 is depicted where, internally, the rechargeable battery 33A is contained and held (not shown). In addition on the face of the earpiece 32 are shown the various control buttons and devices: on/off cell phone button 41; direct connect to Internet 43; location and surveillance finder 45; overall power button 46; volume control 47; and call waiting 48. One skilled in the art appreciates these features are normally integral to the cellular telephone 34 but are not a part of the separate earpiece 32. Having these features incorporated with the earpiece is in part the unique advantage of the CELLULAR TELEPHONE SYSTEM IMPROVEMENT—Known as the “007 WEB” 30.

Another part of FIG. 2 portrays the single in-line memory module (SIMMS) chip 31. Here the SIMMS chip 31 shows the actual Integrated circuit 39 on the heat sink 40. The Integrated circuit 39 is the key to the entire concept of the CELLULAR TELEPHONE SYSTEM IMPROVEMENT—Known as the “007 WEB” 30. This circuit 39 is specifically designed to contain and empower the telephone 34 and earpiece 32 to provide and activate the various features described below in Table A. One skilled in the art of electronic designs appreciates these designs of integrated chips 39 may be accomplished in many different ways but each way could result in the same feature availability or enhancement. The unique features of the CELLULAR TELEPHONE SYSTEM IMPROVEMENT—Known as the “007 WEB” 30 are available to some extent with PDAs. However, the computer industry has largely “taught away” from these to be incorporated as part of the cellular telephone 34. Possibly, this was due in part to the relatively larger size circuits 39 which drove the intermediate technology to a larger PDA device. With increased miniaturization of electronics and media storage, one skilled in electronics appreciates that technology advancements now support placing and including the exemplary features stated below in the smaller telephone unit 34. FIG. 2 further shows the main telephone unit 34 with the compartment 35 and the rechargeable battery 33A.

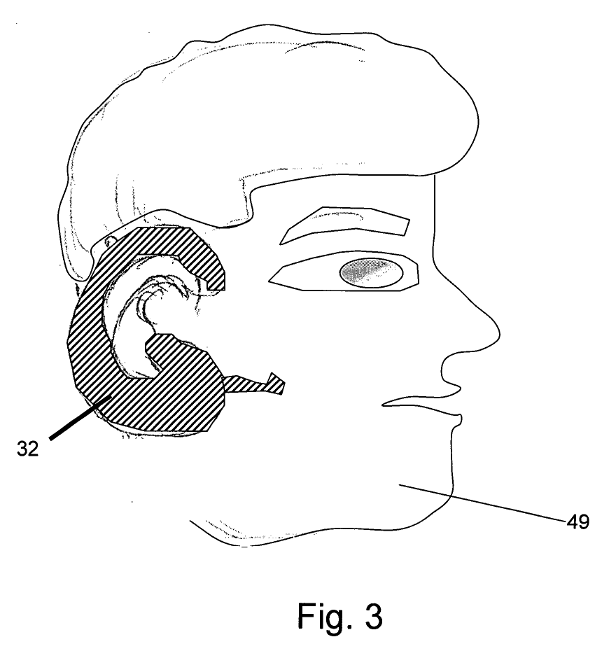

FIG. 3 shows a simple example of a person 49 using the earpiece 32.

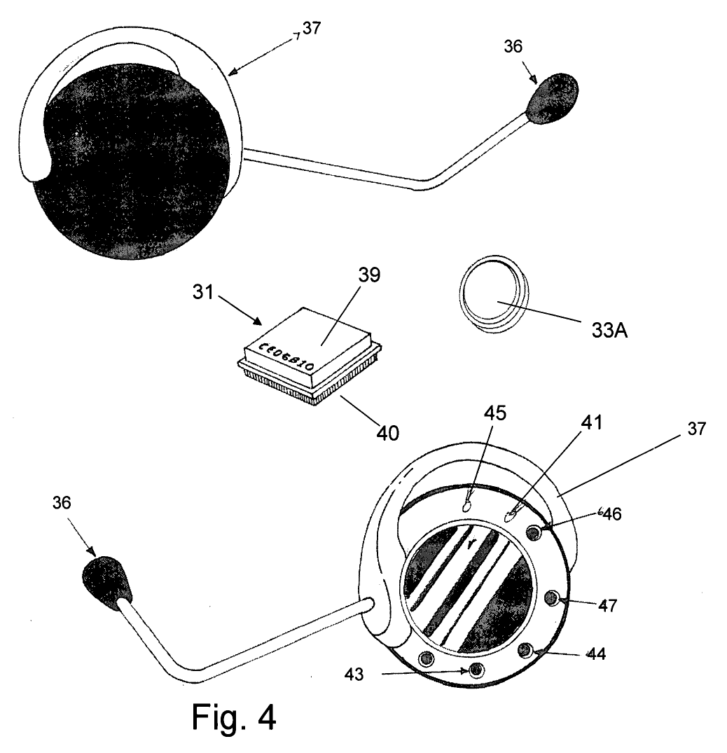

FIG. 4 shows a series of drawings with several more of the subcomponents. This view has the same subcomponents and parts as described above for FIG. 2. That description is incorporated by reference for this FIG. 4.

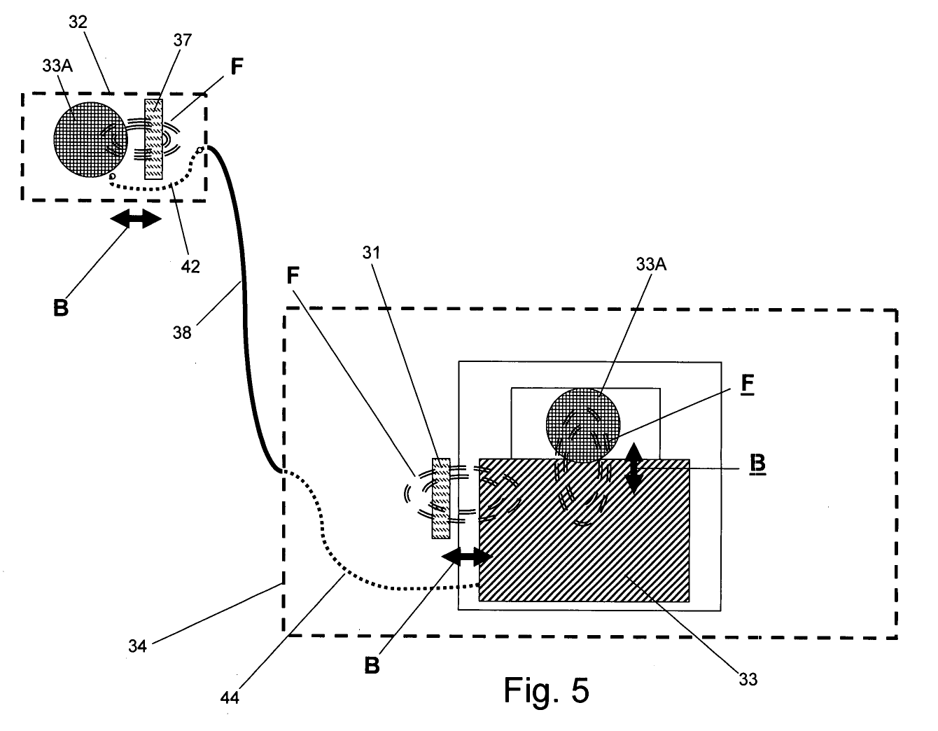

FIG. 5 shows a drawing of the earpiece 32 and telephone 34 with the magnetic boosts B displayed. In this view, the main telephone 34 houses the SIMMS chip 31, the main battery 33, and the rechargeable back-up battery 33A. One skilled in the art appreciates that in a normal telephone system, the main battery 33 is recharged by placing the whole unit into a “re-charger” that normally is powered by Alternating house current (10 Volts, 60 HZ) which is transformed through a charger to power and recharge the Direct Current main battery 33.

The unique placement of the chip 31 and battery 33 here permits the main battery 33 to boost B and charge the disk battery 33A by the electromagnetic flux F. This allows the battery 33A to have a relatively longer life before needing replaced or recharged. Simultaneously, the main battery 33 boosts the SIMMS chip 31 by means of the electromagnetic flux F. This boost B provides the SIMMS circuit 31 with additional power and storage capability. This provides added capacity for the features and functions of the CELLULAR TELEPHONE SYSTEM IMPROVEMENT—Known as the “007 WEB” 30.

In the other part of the view in FIG. 5 the flux F from the battery 33A serves again to boost B the capacity of the SIMMS circuit 31. Any residual power during the flux exchange F and boost B power exchange may be recouped and recycled to the main battery 33 by means of an interconnect system. Here that system is physically portrayed by a series of connections 42, 38 and 44. This is exemplary and not limiting to the means by which the residual power is restored into the main battery 33.

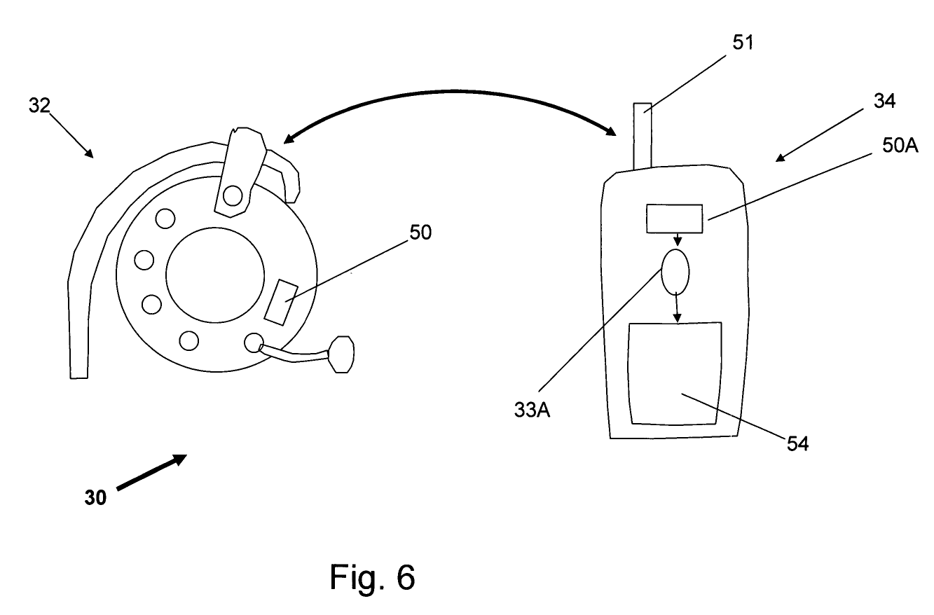

FIGS. 6, 7, and 8, are sketches with several subcomponents shown. These are replications of the original sketches by inventor and serve to display the scope and spirit of his invention for a CELLULAR TELEPHONE SYSTEM IMPROVEMENT—Known as the “007 WEB” 30. These sketches, together with the rest of this written description, the drawings and the inventor's addendum provide a clear understanding of the components and subcomponents included in this invention.

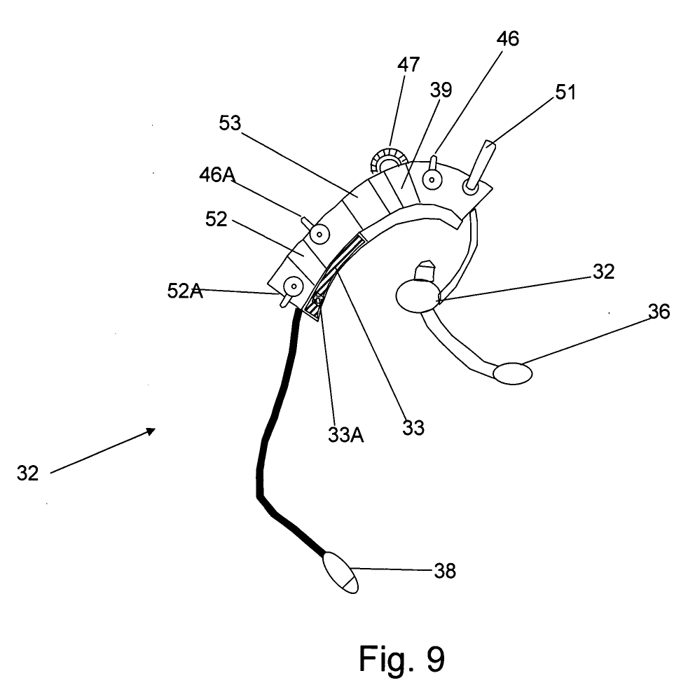

FIG. 9 is a replication of an original sketches by inventor and serves to display an alternative embodiment of the CELLULAR TELEPHONE SYSTEM IMPROVEMENT—Known as the “007 WEB” 30 with various switches and components. The components are similar to those referred to and described in FIG. 2, above, and are incorporated by reference for the description of FIG. 9.

One skilled in the art of cellular and computer media exchange devices well appreciates that similar functions and features expressed here are exemplary and not limiting to the scope and spirit of Cellular Telephone System Improvement—“007 WEB” 30.

In total all the points and details mentioned here throughout this detailed description of the drawings are exemplary and not limiting. Other components specific to describing a general Cellular Telephone System Improvement —“007 WEB” 30 may be added as a person having ordinary skill in the field of this invention well appreciates. The drawing and components have been focused on the parts shown in respect to the present invention.

Operation of the Embodiment

The new general Cellular Telephone System Improvement—“007 WEB” 30 as the present invention has been described in the above embodiment. The manner of how the Cellular Telephone System Improvement known as the “007 WEB” 30 operates is described below. One notes well that the description above, the included detailed drawings, and the operation described here must be taken together to fully illustrate the concept of the Cellular Telephone System Improvement known as the “007 WEB” 30. The manner in which the Cellular Telephone System Improvement known as the “007 WEB” 30 are used can be demonstrated in the following Tables and discussion of the Drawings.

Several ways that Cellular Telephone System Improvement known as the “007 WEB” 30 may be used and the variety of features incorporated are shown in Table A. One skilled in the art of electronic devices such as described here understands there is a plethora of potential features. Therefore those shown here are exemplary and not limiting in the spirit and scope of this invention. Additionally, it is well understood that the power and storage of data for electronic devices continues to become much smaller in physical size. As this occurs, features (that are today thought to be too large for cellular telephones) will be added once the miniaturizing of the technology is achieved. Therefore those features are also incorporated under this concept and invention.

TABLE A
Examples of Uses and Features for Cellular
Telephone System Improvement known as the “007 WEB” 30

| | | How | Advantage or | |
|---|---|---|---|---|
| Feature | Description | Implemented | Improvement | Current |
| 1 | Connected to | Simms 31 | Safety | Not |
| | Amber Alert | “drop-in” | | connected |
| | System | | | yet |
| 2 | Split Screen to | Simms 31 | Vision Phone | Short |
| | see all parties | “drop-in” | | segments |
| | | | | only |
| 3 | Split Screen to | Simms 31 | Control over | Beyond |
| | see all parties | “drop-in” | who sees whom | current |
| | with a block | | | technology |
| | button to | | | |
| | prevent two-way | | | |
| | visual unless | | | |
| | desired | | | |
| 4 | Cable and local | Simms 31 | TV monitor to | PDAs only |
| | TV download | “drop-in” | TV monitor | |
| 5 | Cable and local | Simms 31 | TV monitor to | PDAs only |
| | TV live | “drop-in” | TV monitor | |
| 6 | Full Movie | Simms 31 | Current are | Loggerheads |
| | Download (Buy) | “drop-in” | small | with |
| | | | segments | technology |
| | | | | and movie |
| | | | | industry |
| 7 | Full Movie | Simms 31 | Current are | Connection |
| | Download (Rent) | “drop-in” | small | to rental |
| | | | segments | companies |
| | | | | and verification |
| | | | | of POS - Point of |
| | | | | Sales |
| 8 | Pay for view on | Simms 31 | Current are | Market |
| | cable phones | “drop-in” | text updates | product |
| | | | or snippets | |
| | | | of film | |
| 9 | Ability to | Simms 31 | Not required | Only with |
| | download with | “drop-in” | to be | phone active |
| | phone “off” | | actively | |
| | | | connected | |
| 10 | News papers and | Simms 31 | Only w/ PDAs | Short news |
| | magazine | “drop-in” | | concept only |
| | downloads | | | tested with |
| | | | | phones |
| 11 | Back-up and | Simms 31 | Magnetic | Unfound with |
| | main energy | “drop-in” | Boost B for | small |
| | source “backed- | | better | systems |
| | up” with energy | | reception | |
| | friendly and | | | |
| | adaptable | | | |
| | “magnetic | | | |
| | boost” system B | | | |
| 12 | Web TV Live | Simms 31 | Use with | Current with |
| | compatible in | “drop-in” | Phones 34 | PDAs |
| | format and | | | |
| | content | | | |
| 13 | Home telephone | Simms 31 | Ability to | Undefined |
| | and internet | “drop-in” | talk to | |
| | compatible | | children and | |
| | | | ex-wife. | |
| 14 | GPS (location | Simms 31 | Track and | Available as |
| | and time | “drop-in” | dates user | standalone |
| | recorded) | | | device |
| 15 | Step trace | Simms 31 | All within phone | Only in |
| | | “drop-in” | | specific |
| | | | | separate |
| | | | | devices |
| 16 | Handheld word | Simms 31 | Competitive | Limited |
| | notebook | “drop-in” | w/ PDAs | messaging on |
| | | | | phones |
| 17 | New phones or | Simms 31 | Easy upgrades | Limited |
| | used phone | “drop-in” | | SIMMS |
| | compatibility | | | replacement |
| | | | | available |
| | | | | with minimal |
| | | | | functions |
| 18 | Connectible to | Simms 31 | No need for PDA | Done with |
| | laptops & | “drop-in” | | PDAs |
| | desktop comps. | | | |
| 19 | Dictionary, | Simms 31 | Use with | Done with |
| | spelling & | “drop-in” | Phones 34 | PDAs |
| | grammar | | | |
| 20 | Book download | Simms 31 | Use with | Done with |
| | | “drop-in” | Phones 34 | PDAs |
| 21 | Compute/record | Simms 31 | Use with | Done with |
| | taxes | “drop-in” | Phones 34 | PDAs |
| 22 | Flight | Simms 31 | Use with | Done with |
| | arrivals/depart | “drop-in” | Phones 34 | PDAs |
| | ures - video | | | connected to |
| | | | | internet |
| 23 | Memory stick & | Simms 31 | Use with | Done with |
| | other memory | “drop-in” | Phones | PDAs |
| | device | | | |
| | compatible | | | |
| 24 | 50 state | Simms 31 | Use with | Done with |
| | telephone | “drop-in” | Phones 34 | PDAs |
| | directory at | | | connected to |
| | point of use | | | internet |
| 25 | Re-chargeable | Small disk | Use with | Done with |
| | battery 34A in | battery 33A | Phones 34 | PDAs |
| | earpiece 32 and | | | |
| | phone 34 | | | |
| 26 | Rechargeable | Electro- | Use with | Beyond |
| | battery 33A on | magnetic | Phones 34 | current |
| | phone charged | interconnect F | | technology |
| | from “main” | by placement | | |
| | phone battery | of batteries - | | |
| | 33 | main 33 and | | |
| | | rechargeable disk | | |
| 27 | Standard Photo | Simms 31 | Not just | Only with |
| | to Live Action | “drop-in” in | picture but | Computer net |
| | Talk Phone | proximity to | live camera | meetings |
| | | permit | up-feed | |
| | | magnetic flow | | |
| | | F to boost B | | |
| | | chips capacity | | |
| 28 | Locate | Simms 31 | Use with | Done with |
| | restaurants, | “drop-in” | Phones 34 | PDAs |
| | stores, etc | | | connected to |
| | | | | internet |
| 29 | Hearing aid - | Simms 31 | Use with Ear | No known |
| | where earpiece | “drop-in” | piece 32 | current |
| | 32 | | | technology |
| | enhances/aids | | | in place |
| | hearing even | | | |
| | when telephone | | | |
| | 34 is powered “off” | | | |

Finally, the Cellular Telephone System Improvement —“007 WEB” 30 invention has been described above in connection with what is presently considered to be the most practical embodiments. With this description it is to be understood that the Cellular Telephone System Improvement 30 is not to be limited to the disclosed embodiments. On the contrary, the Cellular Telephone System Improvement 30 is intended to include and be comprised of various modifications and equivalent arrangements of cellular telephonic improvements figures included within the spirit and scope of the description.

What is claimed as new and desired to be protected by Letters Patent is:

1. A cellular telephone improvement device for use with a cellular telephone and an external media database, comprising:
(a) the cellular telephone with an integrated circuit specially configured with a Single Inline Memory Modules chip with a means for performing a series of predetermined functions, with a transceiver for signal exchange, with a power supply, with a viewing screen, and with a means to interconnect the system;
(b) an earpiece with a means to interconnect and to send signals to the cellular telephone, with a series of control switches to start and stop telephone functions, and a power supply;
whereby the device provides an increase in capacity in a data storage means, an enhancement interchanging the data between various media sources, and has significantly increased functionality compared to cellular telephone devices currently in existence.

2. The device according to claim 1 wherein the power supply to the telephone is comprised of a permanent and back-up storage battery which is placed for a purpose in close proximity to the Single Inline Memory Modules chip and the transceiver
Whereby the Single Inline Memory Modules chip is essentially in the electromagnetic path of the power supply.

3. The device according to claim 2 wherein the purpose for proximate placement of the battery to the Single Inline Memory Modules chip and the transceiver is to boost the power and capacity of the chip and the transceiver.

4. The device according to claim 1 wherein the interconnect from the earpiece to the telephone is by means of an electrical wire.

5. The device according to claim 1 wherein the interconnect from the earpiece to the telephone is by means of a transceiver.

6. The device according to claim 5 wherein the power supply to the earpiece is comprised of a storage battery which is placed in close proximity to the transceiver
Whereby the transceiver is essentially configured in the electromagnetic path of the power supply and the transceiver is boosted in capacity by the placement.

7. The device according to claim 1 wherein the series of functions are downloading of a data supply to the telephone for use by a person with the telephone.

8. The device according to claim 7 wherein the function is purchasing and downloading a full-length movie.

9. The device according to claim 7 wherein the function is renting and downloading a full-length movie.

10. The device according to claim 7 wherein the function is downloading a news article from a data source.

11. The device according to claim 7 wherein the downloading function can be accomplished while the telephone is offline.

12. The device according to claim 7 wherein the downloading function is a telephone directory.

13. The device according to claim 7 wherein the downloading function is a map to locate restaurants, stores, shopping locations and entertainment locations.

14. The device according to claim 1 wherein the series of functions are current and live connection with a source of information from a media transmission.

15. The device according to claim 14 wherein the source is an amber alert.

16. The device according to claim 14 wherein the source is a live pay for view event.

17. The device according to claim 14 wherein the source is a weather alert.

18. The device according to claim 1 wherein the series of functions are an ability to split the viewing screen to see a party with whom the telephone is connected to by the transceiver.

19. The device according to claim 18 wherein the ability to view may be disabled to prevent viewing of the parties.

20. A cellular telephone improvement device for use with a cellular telephone and an external media database, comprising:
(a) the cellular telephone with an integrated circuit specially configured with a Single Inline Memory Modules chip with a means for performing a series of predetermined functions, with a transceiver for signal exchange, with a battery power supply in close proximity to the chip, with a viewing screen, and with a means to interconnect the system;
(b) an earpiece with a transceiver connect and to exchange signals with the cellular telephone, with a series of control switches to start and stop telephone functions, and a battery power supply in close proximity to the transceiver
whereby the device provides an increase in capacity in a data storage means, an enhancement interchanging the data between various media sources, and has significantly increased functionality compared to cellular telephone devices currently in existence.
